(19) United States
(12) Patent Application Publication
(10) Pub. No.: US 2021/0039510 A1
(43) Pub. Date: Feb. 11, 2021

(54) WIND AND SOLAR POWER ELECTRIC GENERATOR DEVICE

(71) Applicant: Chin-Yi Chen, Taichung City (TW)

(72) Inventor: Chin-Yi Chen, Taichung City (TW)

(21) Appl. No.: 16/533,472

(22) Filed: Aug. 6, 2019

(51) Int. Cl. B60L 53/00; H02J 7/35; H02J 7/14; B60L 8/00

(52) U.S. Cl. CPC B60L 53/00; H02J 7/35; B60Y 2200/92; B60L 8/003; B60L 8/006; H02J 7/1415

(57) ABSTRACT

The present invention provides a wind and solar power electric generator, with application in a moving vehicle, wherein the vehicle is internally installed with rechargeable batteries. The front of the vehicle is provided with an engine cover and an air inlet, and the rear of the vehicle is fitted with a windshield. The top portion of the vehicle is provided with a top portion solar panel, and the power generated by the top portion solar panel connects to the rechargeable batteries. The present invention is characterized in that a front solar panel is assembled on the engine cover, and front fan electric generators are additionally installed at the air inlet, and the total electric power generated by the front solar panel and the front fan electric generators connects to the rechargeable batteries.

### BACKGROUND OF THE INVENTION

### (a) Field of the Invention

The present invention relates to a wind and solar power electric generator device, and more particularly to a wind and solar power electric generator device that increases the area of solar panels for moving vehicles and additionally installs front fan electric generators, thereby enabling concurrent use of solar energy and wind power electric generator devices to charge batteries when a vehicle is stationary, with additional charging when the vehicle is moving, thus achieving battery charging at all times.

### (b) Description of the Prior Art

It's well known that conventional vehicles use gasoline as the fuel source for the engine, whereas current hybrid electric vehicles use both gasoline and electricity as the power sources, or use electric power as the only power source. Frequently used energy sources include fuel oil, batteries, fuel cells, solar cells, and compressed gas. And commonly used drive systems include technologies such as the internal combustion engine, electric motor, and the turbine. Hybrid electric powered vehicles are able to jointly use an electric motor and an internal combustion engine as the driving sources, or plug-in hybrid powered vehicles use a charging station or household charging equipment to charge the vehicle batteries from a transmission network, all of which need an abundant power supply. However, for the majority of vehicles, regardless of whether they are hybrid electric powered vehicles or plug-in hybrid powered vehicles, the length of time the vehicle is stationary is far greater than the length of time when moving.

Gasoline engine powered vehicles, hybrid electric powered vehicles, or plug-in hybrid powered vehicles of the prior art all need a period of time for charging the vehicle battery, which exasperates the user.

Hence, in light of the aforementioned shortcomings, the inventor of the present invention has actively spearheaded development and carried out continued tests on different structural assemblies, accumulating experience to finally achieve producing a new invention that adequately resolves the aforementioned weaknesses.

### SUMMARY OF THE INVENTION

The present invention is to provide a wind and solar power electric generator device with application in a moving vehicle, wherein the vehicle is internally installed with rechargeable batteries, and the exterior is provided with a top portion and an engine cover. The front end of the vehicle is provided with an air inlet, and the rear end of the vehicle is provided with a windshield. The top portion of the vehicle is provided with a top portion solar panel, and the electric power generated by the top portion solar panel connects to the rechargeable batteries. The present invention is characterized in that: a front solar panel is assembled on the engine cover, and the electric power generated by the front solar panel on the engine cover connects to the rechargeable batteries; moreover, front fan electric generators are additionally installed at the air inlet, and the electric power generated by the front fan electric generators connects to the rechargeable batteries.

Accordingly, the primary objective of the wind and solar power electric generator device of the present invention lies in increasing the area of solar panels for a vehicle and additionally installing the front fan electric generators, thereby providing electric generator devices that use solar power and wind power to concurrently generate electric power.

A second object of the wind and solar power electric generator device of the present invention lies in enabling battery charging when a vehicle is stationary, with additional charging when the vehicle is moving, and thus enable battery charging at all times to supply electric power to engine powered vehicles, hybrid electric powered vehicles, or plug-in hybrid powered vehicles.

Another object of the wind and solar power electric generator device of the present invention lies in additionally installing rear fan electric generators on the windshield at the rear end of the vehicle, which further increases the quantity of electricity generated, providing application in vehicles with no trunk cover.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a side planar schematic view of the present invention.

FIG. 2 is an overhead planar schematic view of the present invention.

FIG. 3 is a front planar schematic view of the present invention.

### DETAILED DESCRIPTION OF THE PREFERRED EMBODIMENTS

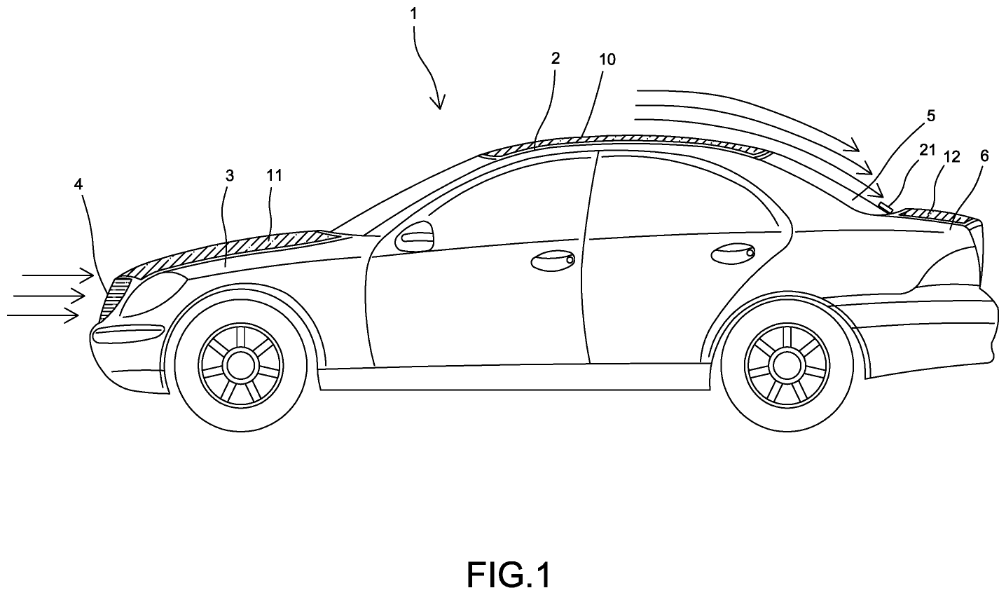

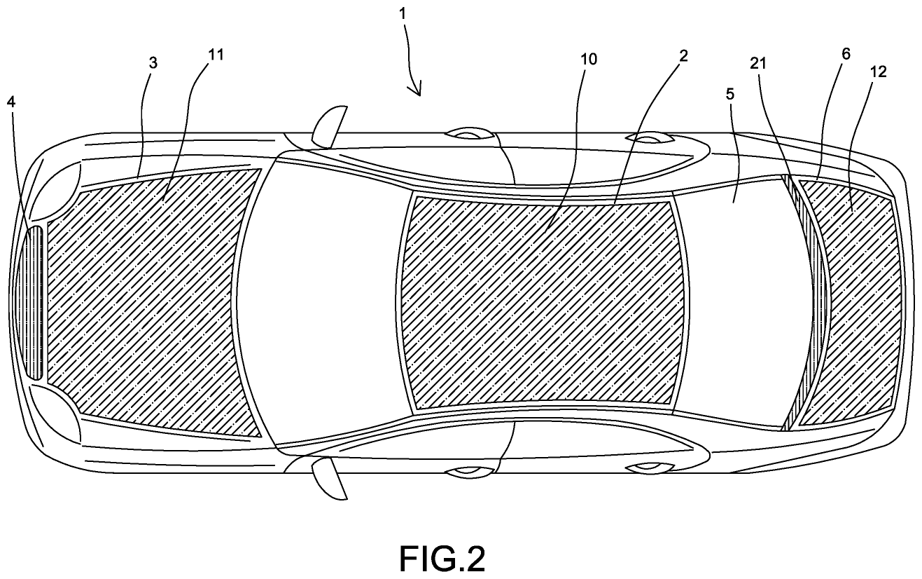

Referring to FIGS. 1, 2, and 3, which show a wind and solar power electric generator device of the present invention, wherein a vehicle 1 internally contains rechargeable batteries (not shown in the drawings), and the exterior of the vehicle 1 is provided with a top portion 2 and an engine cover 3. The front end of the vehicle 1 is provided with an air inlet 4, and the rear end of the vehicle 1 is provided with a windshield 5 or a trunk cover 6 (some vehicles are not provided with the trunk cover 6). A top portion solar panel 10 is assembled on the top portion 2 of the vehicle 1, and the electric power generated by the top portion solar panel 10 connects to the rechargeable batteries. A front solar panel 11 is assembled on the engine cover 3, and the electric power generated by the front solar panel 11 on the engine cover 3 connects to the rechargeable batteries. Front fan electric generators 20 are additionally installed at the air inlet 4, and the electric power generated by the front fan electric generators 20 connects to the rechargeable batteries. And a rear solar panel 12 is assembled on the trunk cover 6, with the electric power generated by the rear solar panel 12 on the trunk cover 6 connected to the rechargeable batteries.

According to the above-described structural improvements in the wind and solar power electric generator device of the present invention, when the vehicle 1 is stationary, if there is sunlight, then the electric power generated by all the solar panels in the top portion solar panel 10, the front solar panel 11, and the rear solar panel 12 receiving the sunlight connects to the rechargeable batteries. Moreover, when the vehicle 1 is moving, the front fan electric generators 20 are subjected to the wind power from a large quantity of air entering the air inlet 4 of the vehicle 1, and the electric power generated therefrom connects to the rechargeable batteries. Hence, with the addition of the top portion solar panel 10, the front solar panel 11, and the rear solar panel 12 concurrently receiving sunlight with the electric power generated therefrom connected to the rechargeable batteries, apart from increasing the area of solar panels for a vehicle compared to conventional vehicle solar panels, the present invention is also additionally installed with the front fan electric generators 20. Furthermore, apart from enabling charging the batteries when the vehicle 1 is stationary, further additional charging is enabled when the vehicle 1 is moving. Accordingly, battery charging is enabled at all times, and thus able to supply electric power to gasoline engine powered vehicles, hybrid electric powered vehicles, or plug-in hybrid powered vehicles.

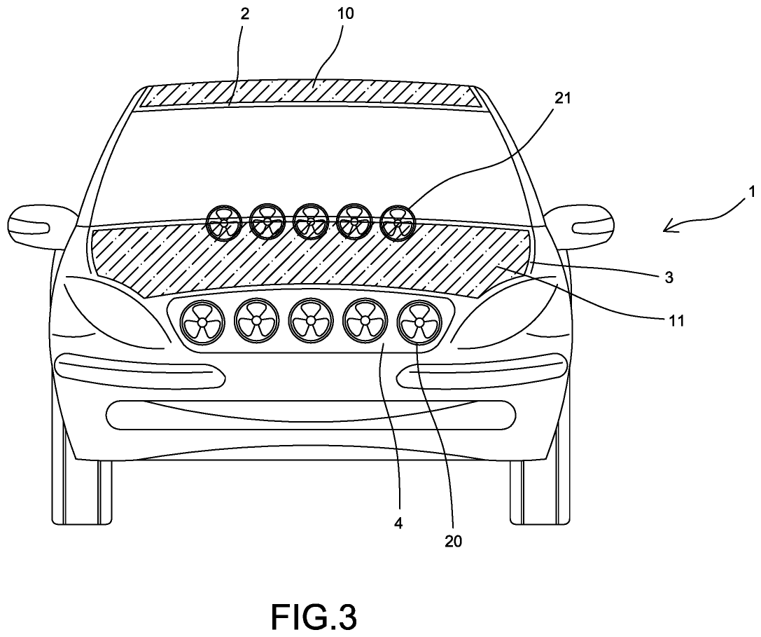

Referring to FIGS. 1 and 3, wherein the windshield 5 at the rear end of the vehicle 1 is further additionally installed with rear fan electric generators 21, and the electric power generated by the rear fan electric generators 21 connects to the rechargeable batteries, which further increases the quantity of electricity generated for application in vehicles with no trunk cover.

The present invention has application in moving vehicles such as cars, motorcycles, tricycles, and bicycles, on rooftops, or for use when camping outdoors, and uses wind and solar power to generate electric power on a small scale that concurrently uses both wind power and solar energy to supplement insufficient power generation from solar energy alone or wind power alone.

In conclusion, the wind and solar power electric generator device of the present invention is thus provided with undoubted originality, practicability, and advancement, and there is no doubt that it clearly complies with the essential elements as required for a new patent. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A wind and solar power electric generator device, for a moving vehicle, an interior of the vehicle contains a rechargeable battery, and an exterior is provided with a top portion and an engine cover, a front end of the vehicle is provided with an air inlet, and a rear end of the vehicle is provided with a windshield, a top portion of the vehicle is provided with a top portion solar panel, and an electric power generated by the top portion solar panel connects to the rechargeable battery; wherein, a front solar panel is assembled on the engine cover, and the electric power generated by the front solar panel on the engine cover connects to the rechargeable batteries; moreover, a front fan electric generator is additionally installed at the air inlet, and the electric power generated by the front fan electric generator connects to the rechargeable battery.

2. The wind and solar power electric generator device according to claim 1, wherein the vehicle is provided with a trunk cover, and a rear solar panel is assembled on the trunk cover, with the electric power generated by the rear solar panel on the trunk cover connected to the rechargeable battery.

3. The wind and solar power electric generator device according to claim 1, wherein the windshield at the rear end of the vehicle is additionally installed with a rear fan electric generator, and the electric power generated by the rear fan electric generator connects to the rechargeable battery.
